(19) United States
(12) Patent Application Publication
(10) Pub. No.: US 2006/0028952 A1
(43) Pub. Date: Feb. 9, 2006

(54) Method for fabricating a molding core for a light guide plate

(76) Inventors: Tai-Cherng Yu, Tu-Chen (TW); Charles Leu, Fremont, CA (US); Ga-Lane Chen, Fremont, CA (US)

Correspondence Address: WEI TE CHUNG;FOXCONN INTERNATIONAL, INC., 1650 MEMOREX DRIVE, SANTA CLARA, CA, 95050, US

(21) Appl. No.: 10/914,938

(22) Filed: Aug. 9, 2004

(30) Foreign Application Priority Data
Aug. 8, 2004 (TW) 92121874

(51) Int. Cl. G11B 7/00

(52) U.S. Cl. 369/100

(57) ABSTRACT

A method for fabricating a molding core (700) for a light guide plate includes: (a) providing a substrate (500) having a photo-resist layer (600) coated thereon; (b) exposing and developing the photo-resist layer to form a photo-resist pattern (640); (c) coating a nickel film (720) on the substrate; (d) electroforming a nickel layer (740) on the nickel film; and (e) separating the nickel layer and film from the substrate and photo-resist pattern, the nickel layer and film thereby providing the core. The nickel film and the nickel layer use a same metal; that is, nickel. Thus, unlike in the prior art, there is no need for an etching step to remove the metal film after electroforming. The method has reduced complexity and cost. In addition, the pattern of the core is more similar to the predetermined pattern of the photo-mask. That is, the precision of the core is significantly increased.

### BACKGROUND OF THE INVENTION

1. Field of the Invention

The present invention relates to a method for fabricating a molding core for a light guide plate, the light guide plate typically being used in a liquid crystal display (LCD) device.

2. Description of the Prior Art

A liquid crystal display is capable of displaying a clear and sharp image through millions of pixels of image elements. It has thus been applied to various electronic equipment in which messages or pictures need to be displayed, such as mobile phones and notebook computers. However, liquid crystals in the liquid crystal display do not themselves emit light. The liquid crystals have to be lit up by a light source so as to clearly and sharply display text and images. The light source may be ambient light, or a backlight system attached to the liquid crystal display.

A conventional backlight system generally comprises a plurality of components, such as a light source, a reflective plate, a light guide plate, a diffusion plate and a prism layer. Among these components, it is generally accepted that the light guide plate is the most crucial component in determining the performance of the backlight system. The light guide plate serves as an instrument for receiving light beams from the light source, and for evenly distributing the light beams over an entire output surface of the light guide plate through reflection and diffusion. In order to keep light evenly distributed over an entire surface of the associated liquid crystal display, the diffusion plate is generally arranged on top of the output surface of the light guide plate.

Conventionally, there are two important kinds of methods for fabricating a light guide plate: printing processes and non-printing processes. In a typical printing process, marks are coated on a bottom surface of a transparent plate, so as to form an array of dots that can scatter and reflect incident light beams. The dots can totally eliminate internal reflection of light beams in the transparent plate, and make the light beams evenly emit from a light emitting surface of the transparent plate. However, the precision of the printing process is difficult to control, and printing processes are gradually being replaced by non-printing processes.

A typical non-printing process includes transferring predetermined patterns onto a molding core, and then forming a light guide plate with the core by an injection molding method or a mechanical imprinting method. Therefore, the method used for fabricating the molding core having the patterns is very important.

Referring to FIG. 7, Taiwan Patent Publication No. 514766 issued on Dec. 21, 2002 discloses a method for fabricating a molding core for a light guide plate. The method includes the following steps: (1) coating a photo-resist layer on a substrate; (2) exposing and developing the photo-resist layer to form a photo-resist pattern; (3) forming a copper (Cu) layer on the photo-resist pattern and areas of the substrate uncovered by the photo-resist pattern; (4) electroforming a core being made of nickel (Ni) on the substrate; (5) separating the substrate from the core having the Cu layer; and (6) etching the Cu layer off from the core.

The above method requires that the copper layer be etched off after the electroforming has been completed. This makes the process unduly complex. In addition, the etching step constitutes another stage in which the precision of the photo-resist pattern is compromised on the way to reaching the final finished core

It is desired to provide an improved method for fabricating a molding core for a light guide plate that overcomes the above-described problems.

### SUMMARY OF THE INVENTION

Accordingly, an objective of the present invention is to provide a method for fabricating a molding core for a light guide plate, the method being simple and the core having high precision.

In order to achieve the above-mentioned objective, a method of the present invention for fabricating a molding core for a light guide plate comprises the following steps: (a) providing a substrate having a photo-resist layer coated thereon; (b) exposing and developing the photo-resist layer to form a photo-resist pattern; (c) coating a nickel film on the substrate; (d) electroforming a nickel layer on the nickel film; and (e) separating the nickel layer and film from the substrate and photo-resist pattern, the nickel layer and film thereby providing the core.

According to the present invention, the nickel film and the nickel layer use a same metal; that is, nickel. Thus, unlike in the prior art, there is no need for an etching step to remove the metal film after electroforming. The method has reduced complexity and cost. In addition, compared with the prior art, the pattern of the core is more similar to the predetermined pattern of the photo-mask. That is, the precision of the core is significantly increased

Other objects, advantages and novel features of the present invention will be apparent from the following detailed description of preferred embodiments thereof with reference to the attached drawings, in which:

### BRIEF DESCRIPTION OF THE DRAWINGS

FIG. 1 is a schematic, side cross-sectional view of a substrate having a photo-resist layer coated thereon, according to the method of the present invention;

FIG. 2 is similar to FIG. 1, but showing the substrate after an exposing step has been completed, whereby a photo-resist pattern is formed;

FIG. 3 is similar to FIG. 2, but showing the substrate after developing and heating steps have been completed, whereby top portions of the photo-resist pattern have curved surfaces;

FIG. 4 is similar to FIG. 3, but showing the substrate after a nickel film has been coated thereon;

FIG. 5 is similar to FIG. 4, but showing the substrate after an electroforming step has been completed, whereby a nickel layer is formed on the nickel film;

FIG. 6 is similar to FIG. 5, but showing the nickel layer and film after the substrate and the photo-resist pattern have been separated therefrom, the nickel layer and film constituting a molding core; and

FIG. 7 is a flow chart of a conventional method for fabricating a molding core for a light guide plate.

### DETAILED DESCRIPTION OF THE INVENTION

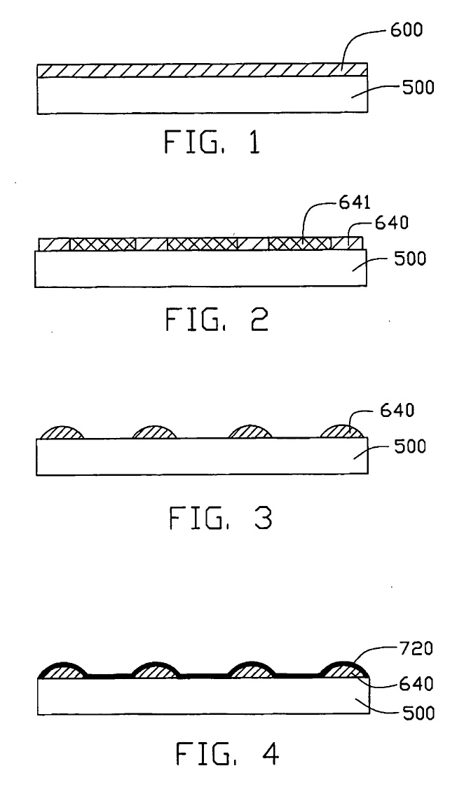

As shown in FIGS. 1˜6, a method for fabricating a molding core 700 for a light guide plate in accordance with the present invention includes six steps.

In the first step, a substrate 500 is provided, as shown in FIG. 1. The substrate 500 is made of a silicon wafer or glass. The substrate 500 is baked in a vacuum or in a nitrogen environment at a temperature between 100° C. and 120° C. for 4˜6 minutes, in order to dehydrate the substrate 500. After that, a photo-resist layer 600 is coated on the substrate 500 by a spin-coating method or a spray-coating method. The photo-resist layer 600 is an organic, positive photo-resist such as Bakelite™. Alternatively, a negative photo-resist can be used. A thickness of the photo-resist layer 600 is in the range from 20˜25 mm. Then, the substrate 500 having the photo-resist layer 600 is baked at a temperature between 90° C. and 100° C. for 20˜30 minutes.

In the second step, the photo-resist layer 600 is exposed and developed, as shown in FIGS. 2 and 3. Ultraviolet (UV) radiation is emitted through a photo-mask (not shown) onto the photo-resist layer 600. The photo-mask has a predetermined pattern. In the preferred embodiment, the pattern includes circles, and the circles are opaque micro-dots. Alternatively, the circles can be transparent when a negative photo-resist is used. Parts of the photo-resist layer 600 receiving the UV radiation are exposed to form an exposed photo-resist area 641, with the remainder of the photo-resist layer 600 forming a photo-resist pattern 640. The photo-resist pattern 640 has opaque micro-dots corresponding to the pattern of the photo-mask. After exposure, a baking step is performed again. The substrate 500 having the exposed photo-resist area 641 and the photo-resist pattern 640 is baked at a temperature between 100° C. and 120° C. for 20˜30 minutes, in order to make the photo-resist pattern 640 resistant to being dissolved. Then, a developer is sprayed onto the photo-resist layer 600, and the substrate 500 is maintained for 30˜60 seconds in order that the exposed photo-resist area 641 is fully dissolved. After developing, the substrate 500 is heated, so that the photo-resist pattern 640 starts to melt. Due to surface tension and intermolecular forces, top portions of the photo-resist pattern 640 form curved surfaces.

In the third step, a thin nickel (Ni) thin film 720 is formed on the substrate 500 by way of sputtering, as shown in FIG. 4. In particular, after the substrate 500 is cooled down following the above-described baking, the substrate 500 is put into a sputtering machine. Under a working pressure of 0.05 torr, a plasma reacting gas is accelerated to bombard the substrate 500. Thus the nickel film 720 having a thickness in the range from 200˜500 Å is formed on the substrate 500. Alternatively, the nickel film 720 can be formed by an evaporation method.

In the fourth step, a nickel layer 740 is electroformed on the nickel film 720, as shown in FIG. 5. The substrate 500 is immersed into an electroforming solution. The nickel layer 740 having a thickness in the range from 0.4˜2 mm is formed on the substrate 500. The electroforming solution includes a nickel-containing solution such as a nickel sulfate solution, a hypophosphite solution, and an accelerant. Alternatively, a nickel chloride solution can be used instead of the nickel sulfate solution. The accelerant is an alkali halide. Moreover, the electroforming solution also includes a pH regulator, a wetting agent and a lustering agent to enhance the quality of electroforming. A pH value of the electroforming solution is in the range from 4.2˜4.8, and can be regulated by the pH regulator.

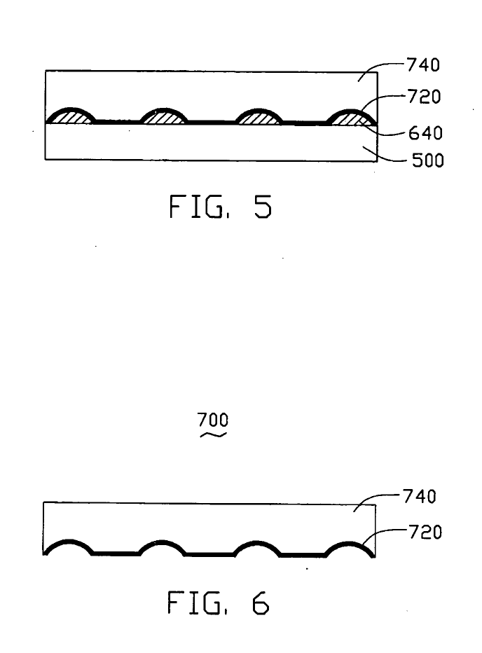

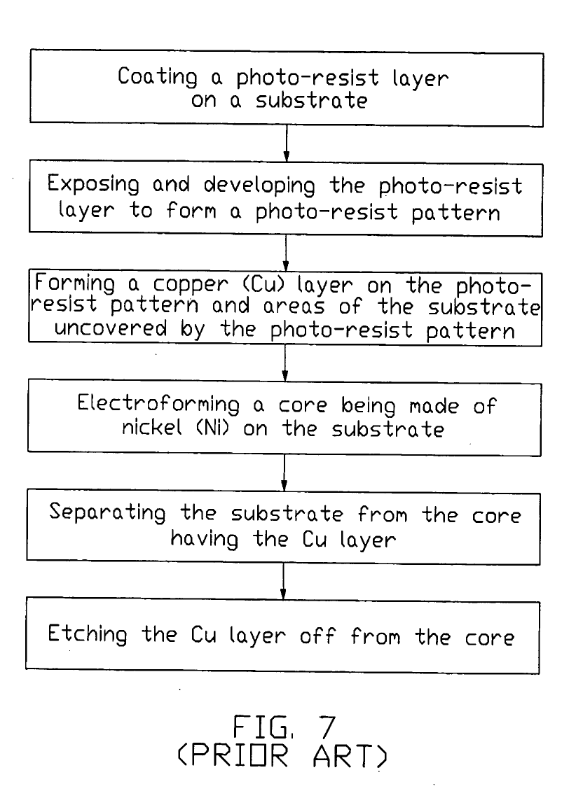

In the fifth step, the nickel layer 740 and nickel film 720 is separated from the substrate 500 and photo-resist pattern 640, as shown in FIG. 6. The freestanding nickel layer 740 and nickel film 720 constitutes the finished core 700.

In summary, the nickel film 720 and the nickel layer 740 use a same metal; that is, nickel. Thus, unlike in the prior art, there is no need for an etching step to remove the metal film after electroforming. The method has reduced complexity and cost. In addition, compared with the prior art, the pattern of the core 700 is more similar to the predetermined pattern of the photo-mask. That is, the precision of the core 700 is significantly increased.

It is to be understood that even though numerous characteristics and advantages of the present invention have been set out in the foregoing description, together with details of the steps and function of the invention, the disclosure is illustrative only, and changes may be made in detail, especially in matters of arrangement of steps within the principles of the invention to the full extent indicated by the broad general meaning of the terms in which the appended claims are expressed.

We claim:

1. A method for fabricating a molding core for a light guide plate, comprising:
(a) providing a substrate having a photo-resist layer coated thereon;
(b) exposing and developing the photo-resist layer to form a photo-resist pattern;
(c) coating a nickel film on the substrate;
(d) electroforming a nickel layer on the nickel film; and
(e) separating the nickel layer and film from the substrate and photo-resist pattern, the nickel layer and film thereby providing the molding core.

2. The method for fabricating a molding core for a light guide plate as recited in claim 1, wherein the substrate is a silicon wafer.

3. The method for fabricating a molding core for a light guide plate as recited in claim 1, wherein the substrate comprises glass.

4. The method for fabricating a molding core for a light guide plate as recited in claim 1, wherein step (a) comprises baking the substrate in a vacuum or in a nitrogen environment at a temperature between 100° C. and 120° C. for 4˜6 minutes to dehydrate the substrate, and then coating the photo-resist layer on the substrate.

5. The method for fabricating a molding core for a light guide plate as recited in claim 1, wherein the photo-resist layer is spin-coated on the substrate.

6. The method for fabricating a molding core for a light guide plate as recited in claim 1, wherein the photo-resist layer is spray-coated on the substrate.

7. The method for fabricating a molding core for a light guide plate as recited in claim 1, further comprising the step of baking the substrate having the photo-resist layer coated thereon at a temperature between 90° C. and 100° C. for 20˜30 minutes.

8. The method for fabricating a molding core for a light guide plate as recited in claim 1, wherein a pattern of a photo-mask used in the exposing of step (b) has opaque micro-dots.

9. The method for fabricating a molding core for a light guide plate as recited in claim 1, wherein after the exposing of step (b), the substrate is baked at a temperature between 100° C. and 120° C. for 20˜30 minutes.

10. The method for fabricating a molding core for a light guide plate as recited in claim 1, wherein the nickel film is coated on the substrate by sputtering.

11. The method for fabricating a molding core for a light guide plate as recited in claim 1, wherein the nickel film is coated on the substrate by an evaporation method.

12. The method for fabricating a molding core for a light guide plate as recited in claim 1, wherein an electroforming solution used in step (d) includes a nickel-containing solution, a hypophosphite solution, and an accelerant.

13. The method for fabricating a molding core for a light guide plate as recited in claim 12, wherein the nickel-containing solution is a nickel sulfate solution or a nickel chloride solution.

14. The method for fabricating a molding core for a light guide plate as recited in claim 12, wherein the electroforming solution further includes a pH regulator, a wetting agent, and a lustering agent.

15. The method for fabricating a molding core for a light guide plate as recited in claim 12, wherein the accelerant is an alkali halide.

16. The method for fabricating a molding core for a light guide plate as recited in claim 12, wherein a pH value of the electroforming solution is in the range from 4.2˜4.8.

17. A method for fabricating a molding core for a light guide plate, comprising:
(a) providing a substrate having a photo-resist layer coated thereon;
(b) exposing and developing the photo-resist layer to form a photo-resist pattern;
(c) coating a film with a specific metal on the substrate;
(d) electroforming a layer of said specific metal on the nickel film; and
(e) separating the combined layer and film from the substrate and photo-resist pattern, thereby providing the molding core.

18. A molding core comprising:
a layer composed of a specific metal, said layer defining opposite faces thereon;
a plurality of concaves formed in one of said faces; and
a film composed of said specific metal, said being thinner than the layer and applied to said one of said faces; wherein
said layer and said film are made at different stages and by different methods so as to be discrete from each other initially while joined together finally.
